(19) United States
(12) Patent Application Publication
(10) Pub. No.: US 2007/0245334 A1
(43) Pub. Date: Oct. 18, 2007

(54) Methods, media and systems for maintaining execution of a software process

(75) Inventors: Jason Nieh, New York, NY (US); Shaya Joseph Potter, New York, NY (US); Oren Laadan, New York, NY (US)

Correspondence Address: WilmerHale/Columbia University, 399 PARK AVENUE, NEW YORK, NY, 10022, US

(73) Assignee: THE TRUSTEES OF COLUMBIA UNIVERSITY IN THE CITY OF NEW YORK, New York, NY (US)

(21) Appl. No.: 11/584,451

(22) Filed: Oct. 20, 2006

Related U.S. Application Data
(60) Provisional application No. 60/729,094, filed on Oct. 20, 2005.
(60) Provisional application No. 60/729,093, filed on Oct. 20, 2005.

(51) Int. Cl. G06F 9/44

(52) U.S. Cl. 717/168

(57) ABSTRACT

Methods, media and systems for maintaining execution of a software process are provided. In some embodiments, methods for maintaining execution of a software process are provided, comprising: suspending one or more processes running in a virtualized operating system environment on a first digital processing device; saving information relating to the one or more processes; restarting the one or more processes on a second digital processing device; and updating an operating system of the first digital processing device.

### CROSS-REFERENCE TO RELATED APPLICATIONS

This application claims priority under 35 U.S.C. § 119(e) from U.S. Provisional Application No. 60/729,094, filed on Oct. 20, 2005, and U.S. Provisional Application No. 60/729,093, filed on Oct. 20, 2005, which are hereby incorporated by reference in their entireties.

### STATEMENT REGARDING FEDERALLY SPONSORED RESEARCH OR DEVELOPMENT

The government may have certain rights in the present invention pursuant to grants by National Science Foundation, grant numbers ANI-0240525 and CNS-0426623.

### TECHNOLOGY AREA

The disclosed subject matter relates to methods, media and systems for maintaining execution of a software process.

### BACKGROUND

As computers have become faster, cheaper, they have become ubiquitous in academic, corporate, and government organizations. At the same time, the widespread use of computers has given rise to enormous management complexity and security hazards, and the total cost of owning and maintaining them is becoming unmanageable. The fact that computers are increasingly networked complicates the management problem.

One difficult management problem is the application of security updates to networked computers. To prevent viruses and other attacks commonplace in today's networks, software vendors frequently release software updates, often referred to as “security patches,” that can be applied to address security and maintenance issues that have been discovered. For these patches to be effective, they need to be applied to the computers as soon as possible. However, software updates often result in system services downtime. To avoid the possibility of users losing their data, a system administrator must schedule downtime in advance and in cooperation with users, leaving the computer vulnerable until updated. In addition to system downtime, users are forced to incur additional inconvenience and delays in starting applications again and attempting to restore their sessions to the state they were in before being shutdown. Therefore, it is desirable to reduce or eliminate downtime due to security updates and maintenance problems.

### SUMMARY

Methods, media and systems for maintaining execution of a software process are provided. In some embodiments, methods for maintaining execution of a software process are provided, comprising: suspending one or more processes running in a virtualized operating system environment on a first digital processing device; saving information relating to the one or more processes; restarting the one or more processes in another virtualized operating system environment; and updating an operating system of the first digital processing device.

In some embodiments, computer-readable media containing computer-executable instructions that, when executed by a processor, cause the processor to perform a method for maintaining execution of a software process are provided, the method comprising: suspending one or more processes running in a virtualized operating system environment on a first digital processing device; saving information relating to the one or more processes; restarting the one or more processes in another virtualized operating system environment; and updating an operating system of the first digital processing device.

In some embodiments, systems for maintaining execution of a software process are provided, comprising: a migration component configured to migrate one or more processes in a virtualized operating system environment on a digital processing device by suspending the one or more processes, saving information relating to the one or more processes, and restarting the one or more processes in another virtualized operating system environment, and a monitoring component configured to determine whether an operating system of the digital processing device needs to be updated, instruct the migration component to migrate the one or more processes upon determining that the operating system of the digital processing device needs to be updated, and updating an operating system of the digital processing device.

### BRIEF DESCRIPTION OF THE DRAWINGS

The Detailed Description, including the description of various embodiments of the invention, will be best understood when read in reference to the accompanying figures wherein:

FIG. 1 is a block diagram illustrating an operating system virtualization scheme according to some embodiments;

FIG. 2 is a diagram illustrating a method for managing a computer system according to some embodiments; and

FIG. 3 is a block diagram illustrating a system according to some embodiments.

### DETAILED DESCRIPTION

Methods, media and systems for maintaining execution of a software process are provided. In some embodiments, to perform operating system updates and maintenance, applications running on a digital processing device (e.g., a computer) may be migrated to other systems, so that disruptions to services provided by the a digital processing device can be minimized. To this end, a virtualized operating system environment can be used to migrate applications in a flexible manner.

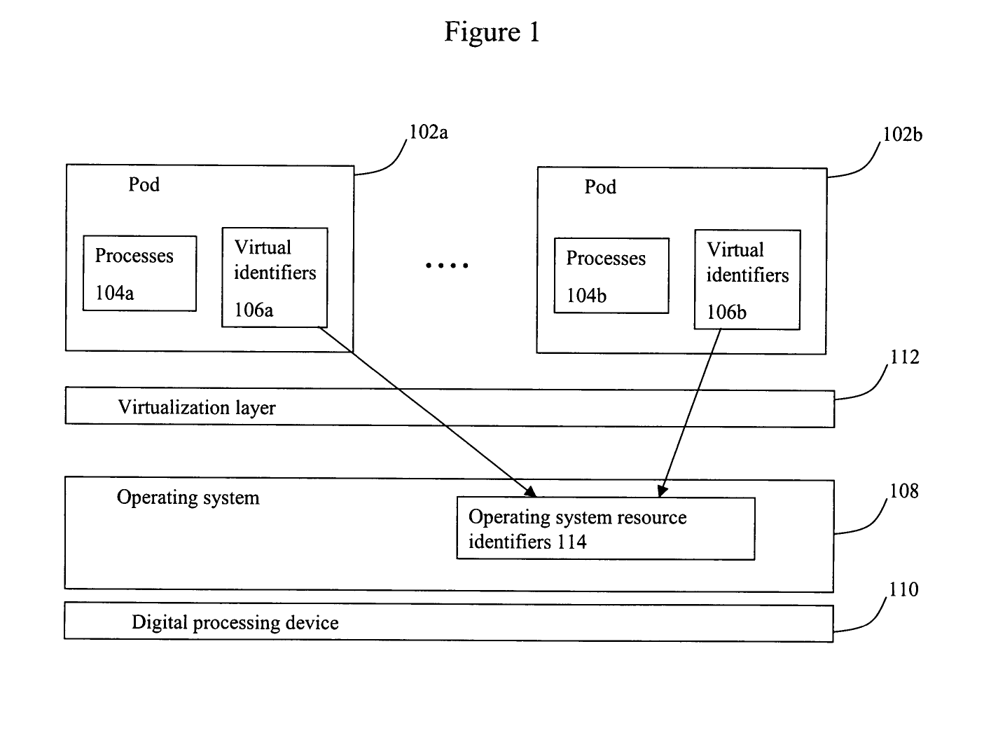

FIG. 1 is a block diagram illustrating an operating system virtualization scheme in some embodiments. An operating system 108 that runs on digital processing device 110 can be provided with a virtualization layer 112 that provides a PrOcess Domain (pod) abstraction. Digital processing device 110 can include, for example, computers, set-top boxes, mobile computing devices such as cell phones and Personal Digital Assistants (PDAs), other embedded systems and/or any other suitable device. One or more pods, for example, Pod 102a and Pod 102b, can be supported. A pod (e.g., pod 102a) can include a group of processes (e.g., processes 104a) with a private namespace, which can include a group of virtual identifiers (e.g., identifiers 106a). The private namespace can present the process group with a virtualized view of the operating system 108. This virtualization provided by virtualization layer 112 can associate virtual identifiers (e.g., identifiers 106a) with operating system resources identifiers 110 such as process identifiers and network addresses. Hence, processes (e.g., processes 104a) in a pod (e.g., pod 102a) can be decoupled from dependencies on the operating system 108 and from other processes (e.g., processes 104b) in the system. This virtualization can be integrated with a checkpoint-restart mechanism that enables processes within a pod to be migrated as a unit to another machine. This virtualization scheme can be implemented to virtualize any suitable operating systems, including, but not limited to, Unix, Linux, and Windows operating systems. This virtualization scheme can be, for example, implemented as a loadable kernel module in Linux.

In some embodiments, by using a pod to encapsulate a group of processes and associated users in an isolated machine-independent virtualized environment that is decoupled from the underlying operating system instance, unscheduled operating system updates can be performed while preserving application service availability. The pod virtualization can be combined with a checkpoint-restart mechanism that uniquely decouples processes from dependencies on the underlying system and maintains process state semantics to enable processes to be migrated across different machines. The checkpoint-restart mechanism introduces a platform-independent format for saving the state associated with processes and pod virtualization. This format can be combined with the use of higher-level functions for saving and restoring process state to provide a high degree of portability for process migration across different operating system versions. In particular, the checkpoint-restart mechanism can rely on the same kind of operating system semantics that ensure that applications can function correctly across operating system versions with different security and maintenance patches.

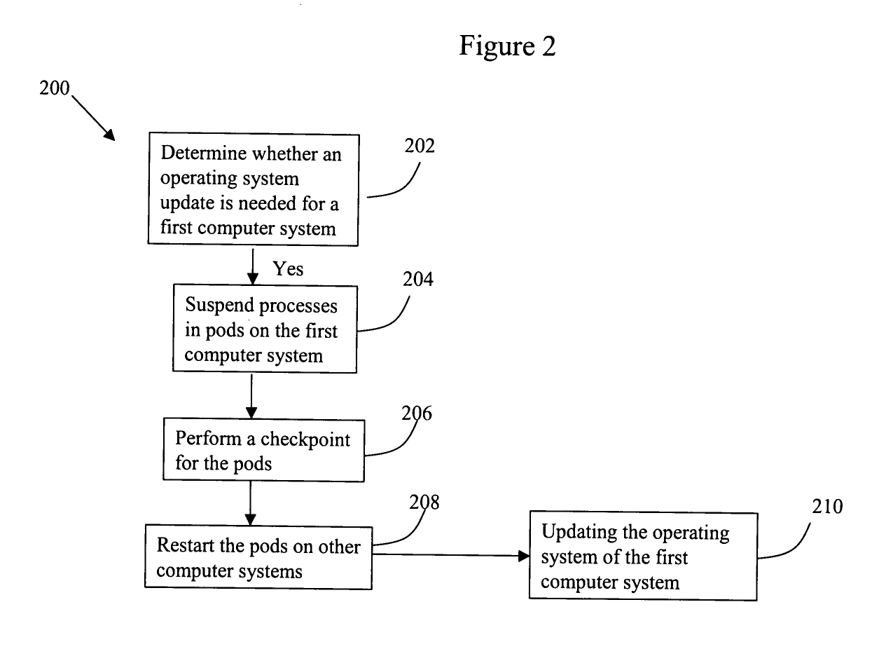

FIG. 2 is a diagram illustrating a method 200 for managing a computer system of various embodiments. At 202, method 200 can determine whether the operating system of a first computer needs to be updated. If yes, processes in pods on the first computer can be suspended at 204, and at 206, a checkpoint can be performed. Then, at 208, the suspended pods can be restarted on other computer systems using information saved during the checkpoint. At 210, an update of the operating system of the first computer can be performed. This can happen at the same time when the pods are being migrated to the other computer systems to continue to provide user services. Therefore, method 200 can be used to maintain application service availability without losing important computational state as a result of system downtime due to operating system upgrades.

In method 200, to determine whether an operating system update is needed at 202, an autonomous system status service can be used. The service monitors a system for system faults as well as security updates. When the service detects new security updates, it is able to download and install them automatically. If the update requires a reboot, the service can use the pod's checkpoint-restart capability to save the pod's state, reboot the machine into the newly fixed environment, and restart the processes within the pod without causing any data loss. This provides fast recovery from system downtime even when other machines are not available to run application services. Alternatively, if another machine is available, the pod can be migrated to the new machine while the original machine is maintained and rebooted, further minimizing application service downtime. This enables security patches to be applied to operating systems in a timely manner with minimal impact on the availability of application services. Once the original machine has been updated, applications can be returned and can continue to execute even though the underlying operating system has changed. Similarly, if the service detects an imminent system fault, the processes can be checkpointed, migrated, and restarted on a new machine before the fault can cause the process' execution to fail.

In some embodiments, server consolidation is provided by allowing multiple pods to be in use on a single machine as shown in FIG. 1, while enabling automatic machine status monitoring. Since each pod provides a complete secure virtual machine abstraction, it is able to run any server application that would run on a regular machine. By consolidating multiple machines into distinct pods running on a single server, one improves manageability by limiting the number of physical hardware and the number of operating system instances an administrator has to manage. Similarly, when kernel security holes are discovered, server consolidation improves manageability by minimizing the amount of machines that need to be upgraded and rebooted. The system monitor further improves manageability by constantly monitoring the host system for stability and security problems.

The private, virtual namespace of pods enables secure isolation of applications by providing complete mediation to operating system resources. Pods can restrict what operating system resources are accessible within a pod by simply not providing identifiers to such resources within its namespace. A pod only needs to provide access to resources that are needed for running those processes within the pod. It does not need to provide access to all resources to support a complete operating system environment. An administrator can configure a pod in the same way one configures and installs applications on a regular machine. Pods enforce secure isolation to prevent exploited pods from being used to attack the underlying host or other pods on the system. Similarly, the secure isolation allows one to run multiple pods from different organizations, with different sets of users and administrators on a single host, while retaining the semantic of multiple distinct and individually managed machines.

For example, to provide a web server, a web server pod can be setup to only contain the files the web server needs to run and the content it wants to serve. The web server pod could have its own IP address, decoupling its network presence from the underlying system. The pod can have its network access limited to client-initiated connections using firewall software to restrict connections to the pod's IP address to only the ports served by applications running within this pod. If the web server application is compromised, the pod limits the ability of an attacker to further harm the system because the only resources he has access to are the ones explicitly needed by the service. The attacker cannot use the pod to directly initiate connections to other systems to attack them since the pod is limited to client-initiated connections. Furthermore, there is no need to carefully disable other network services commonly enabled by the operating system to protect against the compromised pod because those services, and the core operating system itself, reside outside of the pod's context.

Pod virtualization can be provided using a system call interposition mechanism and the chroot utility with file system stacking. Each pod can be provided with its own file system namespace that can be separate from the regular host file system. While chroot can give a set of processes a virtualized file system namespace, there may be ways to break out of the environment changed by the chroot utility, especially if the chroot system call is allowed to be used by processes in a pod. Pod file system virtualization can enforce the environment changed by the chroot utility and ensure that the pod's file system is only accessible to processes within the given pod by using a simple form of file system stacking to implement a barrier. File systems can provide a permission function that determines if a process can access a file.

For example, if a process tries to access a file a few directories below the current directory, the permission function is called on each directory as well as the file itself in order. If any of the calls determine that the process does not have permission on a directory, the chain of calls ends. Even if the permission function determines that the process has access to the file itself, it must have permission to traverse the directory hierarchy to the file to access it. Therefore, a barrier can be implemented by stacking a small pod-aware file system on top of the staging directory that overloads the underlying permission function to prevent processes running within the pod from accessing the parent directory of the staging directory, and to prevent processes running only on the host from accessing the staging directory. This effectively confines a process in a pod to the pod's file system by preventing it from ever walking past the pod's file system root.

Any suitable network file system, including Network File System (NFS), can be used with pods to support migration. Pods can take advantage of the user identifier (UID) security model in NFS to support multiple security domains on the same system running on the same operating system kernel. For example, since each pod can have its own private file system, each pod can have its own /etc/passwd file that determines its list of users and their corresponding UIDs. In NFS, the UID of a process determines what permissions it has in accessing a file.

Pod virtualization can keep process UIDs consistent across migration and keep process UIDs the same in the pod and operating system namespaces. However, because the pod file system is separate from the host file system, a process running in the pod is effectively running in a separate security domain from another process with the same UID that is running directly on the host system. Although both processes have the same UID, each process is only allowed to access files in its own file system namespace. Similarly, multiple pods can have processes running on the same system with the same UID, but each pod effectively provides a separate security domain since the pod file systems are separate from one another. The pod UID model supports an easy-to-use migration model when a user may be using a pod on a host in one administrative domain and then moves the pod to another. Even if the user has computer accounts in both administrative domains, it is unlikely that the user will have the same UID in both domains if they are administratively separate. Nevertheless, pods can enable the user to run the same pod with access to the same files in both domains.

Suppose the user has UID 100 on a machine in administrative domain A and starts a pod connecting to a file server residing in domain A. Suppose that all pod processes are then running with UID 100. When the user moves to a machine in administrative domain B where he has UID 200, he can migrate his pod to the new machine and continue running processes in the pod. Those processes can continue to run as UID 100 and continue to access the same set of files on the pod file server, even though the user's real UID has changed. This works, even if there's a regular user on the new machine with a UID of 100. While this example considers the case of having a pod with all processes running with the same UID, it is easy to see that the pod model supports pods that may have running processes with many different UIDs.

Because the root UID 0 may be privileged and treated specially by the operating system kernel, pod virtualization may treat UID 0 processes inside of a pod specially as well. This can prevent processes running with privilege from breaking the pod abstraction, accessing resources outside of the pod, and causing harm to the host system. While a pod can be configured for administrative reasons to allow full privileged access to the underlying system, there are pods for running application services that do not need to be used in this manner. Pods can provide restrictions on UID 0 processes to ensure that they function correctly inside of pods.

When a process is running in user space, its UID does not have any affect on process execution. Its UID only matters when it tries to access the underlying kernel via one of the kernel entry points, namely devices and system calls. Since a pod can already provide a virtual file system that includes a virtual/dev with a limited set of secure devices, the device entry point may already be secure. System calls of concern include those that could allow a root process to break the pod abstraction. They can be classified into three categories and are listed below:

Category 1: Host Only System Calls

mount—If a user within a pod is able to mount a file system, they could mount a file system with device nodes already present and thus would be able to access the underlying system directly. Therefore, pod processes may be prevented from using this system call.

stime, adjtimex—These system calls enable a privileged process to adjust the host's clock. If a user within a pod could call this system call they can cause a change on the host. Therefore pod processes may be prevented from using this system call.

acct—This system call sets what file on the host BSD process accounting information should be written to. As this is host specific functionality, processes may be prevented from using this system call.

swapon, swapoff—These system calls control swap space allocation. Since these system calls are host specific and may have no use within a pod, processes may be prevented from calling these system calls.

reboot—This system call can cause the system to reboot or change Ctrl-Alt-Delete functionality. Therefore, processes may be prevented from calling it.

ioperm, iopl—These system calls may enable a privileged process to gain direct access to underlying hardware resources. Since pod processes do not access hardware directly, processes may be prevented from making these system calls.

create_nodule, init_nodule, delete_nodule, query_module—These system calls relate to inserting and removing kernel modules. As this is a host specific function, processes may be prevented from making these system calls.

sethostname, setdomainname—These system call set the name for the underlying host. These system calls may be wrapped to save them with pod specific names, allowing each pod to call them independently.

nfsservctl—This system call can enable a privileged process inside a pod to change the host's internal NFS server. Processes may be prevented from making this system call.

Category 2: Root Squashed System Calls

nice, setpriority, sched_setscheduler—These system calls lets a process change its priority. If a process is running as root (UID 0), it can increase its priority and freeze out other processes on the system. Therefore, processes may be prevented from increasing their priorities.

ioctl—This system call is a syscall demultiplexer that enables kernel device drivers and subsystems to add their own functions that can be called from user space. However, as functionality can be exposed that enables root to access the underlying host, all system call beyond a limited audited safe set may be squashed to user “nobody,” similar to what NFS does.

setrlimit—this system call enables processes running as UID 0 to raise their resource limits beyond what was preset, thereby enabling them to disrupt other processes on the system by using too much resources. Processes may be prevented from using this system call to increase the resources available to them.

mlock, mlockall—These system calls enable a privileged process to pin an arbitrary amount of memory, thereby enabling a pod process to lock all of available memory and starve all the other processes on the host. Privileged processes may therefore be reduced to user “nobody” when they attempt to call this system call so that they are treated like a regular process.

Category 3: Option Checked System Calls

mknod—This system call enables a privileged user to make special files, such as pipes, sockets and devices as well as regular files. Since a privileged process needs to make use of such functionality, the system call cannot be disabled. However, if the process creates a device it may be creating an access point to the underlying host system. Therefore when a pod process makes use of this system call, the options may be checked to prevent it from creating a device special file, while allowing the other types through unimpeded.

The first class of system calls are those that only affect the host system and serve no purpose within a pod. Examples of these system calls include those that load and unload kernel modules or that reboot the host system. Because these system calls only affect the host, they would break the pod security abstraction by allowing processes within it to make system administrative changes to the host. System calls that are part of this class may therefore be made inaccessible by default to processes running within a pod.

The second class of system calls are those that are forced to run unprivileged. Just like NFS, pod virtualization may force privileged processes to act as the “nobody” user when they want to make use of some system calls. Examples of these system calls include those that set resource limits and ioctl system calls. Since system calls such as setrtimit and nice can allow a privileged process to increase its resource limits beyond predefined limits imposed on pod processes, privileged processes are by default treated as unprivileged when executing these system calls within a pod. Similarly, the ioctl system call is a system call multiplexer that allows any driver on the host to effectively install its own set of system calls. Pod virtualization may conservatively treat access to this system call as unprivileged by default.

The third class of system calls are calls that are required for regular applications to run, but have options that will give the processes access to underlying host resources, breaking the pod abstraction. Since these system calls are required by applications, the pod may check all their options to ensure that they are limited to resources that the pod has access to, making sure they are not used in a manner that breaks the pod abstraction. For example, the mknod system call can be used by privileged processes to make named pipes or files in certain application services. It is therefore desirable to make it available for use within a pod. However, it can also be used to create device nodes that provide access to the underlying host resources. To limit how the system call is used, the pod system call interposition mechanism may check the options of the system call and only allows it to continue if it is not trying to create a device.

In some embodiments, checkpoint-restart as shown in FIG. 2 can allow pods to be migrated across machines running different operating system kernels. Upon completion of the upgrade process (e.g., at 210 of method 200), the system and its applications may be restored on the original machine. Pods can be migrated between machines with a common CPU architecture with kernel differences that may be limited to maintenance and security patches.

Many of the Linux kernel patches contain security vulnerability fixes, which are typically not separated out from other maintenance patches. Migration can be achieved where the application's execution semantics, such as how threads are implemented and how dynamic linking is done, do not change. On the Linux kernels, this is not an issue as all these semantics are enforced by user-space libraries. Whether one uses kernel or user threads, or how libraries are dynamically linked into a process can be determined by the respective libraries on the file system. Since the pod may have access to the same file system on whatever machine it is running on, these semantics can stay the same. To support migration across different kernels, a system can use a checkpoint-restart mechanism that employs an intermediate format to represent the state that needs to be saved on checkpoint, as discussed above.

In some embodiments, the checkpoint-restart mechanism can be structured to perform its operations when processes are in such a state that saving on checkpoint can avoid depending on many low-level kernel details. For example, semaphores typically have two kinds of state associated with each of them: the value of the semaphore and the wait queue of processes waiting to acquire the corresponding semaphore lock. In general, both of these pieces of information have to be saved and restored to accurately reconstruct the semaphore state. Semaphore values can be easily obtained and restored through GETALL and SETALL parameters of the semcti system call. But saving and restoring the wait queues involves manipulating kernel internals directly. The checkpoint-restart mechanism avoids having to save the wait queue information by requiring that all the processes be stopped before taking the checkpoint. When a process waiting on a semaphore receives a stop signal, the kernel immediately releases the process from the wait queue and returns EINTR. This ensures that the semaphore wait queues are always empty at the time of checkpoint so that they do not have to be saved.

While most process state information can be abstracted and manipulated in higher-level terms using higher-level kernel services, there are some parts that are not amenable to a portable intermediate representation. For instance, specific TCP connection states like time-stamp values and sequence numbers, which do not have a high-level semantic value, have to be saved and restored to maintain a TCP connection. As this internal representation can change, its state needs to be tracked across kernel versions and security patches. Fortunately, there is usually an easy way to interpret such changes across different kernels because networking standards such as TCP do not change often. Across all of the Linux 2.4 kernels, there was only one change in TCP state that required even a small modification in the migration mechanism. Specifically, in the Linux 2.4.14 kernel, an extra field was added to TCP connection state to address a flaw in the existing syncookie mechanism. If configured into the kernel, syncookies protect an Internet server against a synflood attack. When migrating from an earlier kernel to a Linux-2.4.14 or later version kernel, the extra field can be initialized in such a way that the integrity of the connection is maintained. In fact, this is the only instance across all of the Linux 2.4 kernel versions where an intermediate representation is not possible and the internal state had changed and had to be accounted for.

In some embodiments, an autonomic system status service can be used for determining whether an update is needed for a computer system, as called for by method 200 at 202. The service may be able to monitor multiple sources for information and can use this information to make autonomic decisions about when to save pods, migrate them to other machines, and restart them. While there are many items that can be monitored, the service can monitor two items in particular. First, it can monitor the vendor's software security update repository to ensure that the system stays up to date with the latest security patches. Second, it can monitor the underlying hardware of the system to ensure that an imminent fault is detected before the fault occurs and corrupts application state. By monitoring these two sets of information, the autonomic system status service can reboot or shutdown the computer, while saving or migrating the processes. This helps ensure that data is not lost or corrupted due to a forced reboot or a hardware fault propagating into the running processes.

Many operating system vendors provide their users with the ability to automatically check for system updates and to download and install them when they become available. Example of these include Microsoft's Windows Update service, as well as Debian based distribution's security repositories. Users are guaranteed that the updates one gets through these services are genuine because they are verified through cryptographic signed hashes that verify the contents as coming from the vendors. The problem with these updates is that some of them require machine reboots; in the case of Debian GNU/Linux this is limited to kernel upgrades. The autonomic system status service can download all security updates, and by using the pod's checkpoint-restart mechanism, the service can enable the security updates that need reboots to take effect without disrupting running applications and causing them to lose state.

Commodity systems also provide information about the current state of the system that can indicate if the system has an imminent failure on its hands. Subsystems, such as a hard disk's Self-Monitoring Analysis Reporting Technology (SMART), let an autonomic service monitor the system's hardware state. SMART provides diagnostic information, such as temperature and read/write error rates, on the hard drives in the system that can indicate if the hard disk is nearing failure. Many commodity computer motherboards also have the ability to measure CPU and case temperature, as well as the speeds of the fans that regulate those temperatures. If temperature in the machine rises too high, hardware in the machine can fail catastrophically. Similarly, if the fans fail and stop spinning, the temperature will likely rise out of control. The autonomic service can monitor these sensors and if it detects an imminent failure, it can attempt to migrate the pods to a cooler system, as well as shutdown the machine to prevent the hardware from being destroyed.

Many administrators use an uninterruptible power supply (UPS) to avoid having a computer lose or corrupt data in the event of a power loss. While one can shutdown a computer when the battery backup runs low, most applications are not written to save their data in the presence of a forced shutdown. The automatic service can monitor UPS status and if the battery backup becomes low, it can quickly save the pod's state to avoid any data loss when the computer is forced to shutdown.

Similarly, the operating system kernel on the machine monitors the state of the system, and if irregular conditions occur, such as Direct Memory Access (DMA) timeout or needing to reset the Integrated Drive Electronics (IDE) bus, will log this occurrence. The autonomic service can monitor the kernel logs to discover these irregular conditions. When the hardware monitoring systems or the kernel logs provide information about possible pending system failures, the autonomic service saves the pods running on the system, and migrates them to a new system to be restarted. This ensures state is not lost, while informing system administrators that the machine needs maintenance.

Many policies can be implemented to determine which system a pod should be migrated to while a machine needs maintenance. The autonomic service can use a simple policy of allowing a pod to be migrated around a specified set of clustered machines. The autonomic service gets reports at regular intervals from the other machines' autonomic services that reports each machine's load. If the autonomic service decides that it must migrate a pod, it may choose the machine in its cluster that has the lightest load.

Principles for designing and building secure systems include: economy of mechanism (simpler and smaller systems are better because they are easier to understand and to ensure that they do not allow unwanted access); complete mediation (systems should check every access to protected objects); least privilege (a process should only have access to the privileges and resources it needs to do its job); psychological acceptability (if users are not willing to accept the requirements that the security system imposes, such as very complex passwords that the users are forced to write down, security is impaired); and work factor (security designs should force an attacker to have to do extra work to break the system.) Various embodiments can be designed to satisfy these five principles. They can provide economy of mechanism using a thin virtualization layer based on system call interposition and file system stacking that only adds a modest amount of code to a running system. Furthermore, They can be configured so that they change neither applications nor the underlying operating system kernel.

In some embodiments, complete mediation of all resources available on the host machine is provided by ensuring that all resources accesses occur through the pod's virtual namespace. Unless a file, process, or other operating system resource was explicitly placed in the pod by the administrator or created within the pod, the system may not allow a process within a pod to access the resource. It can also provide a least privilege environment by enabling an administrator to only include the data necessary for each service. It can provide separate pods for individual services so that separate services are isolated and restricted to the appropriate set of resources. Even if a service is exploited, it will limit the attacker to the resources the administrator provided for that service. While one can achieve similar isolation by running each individual service on a separate machine, this leads to inefficient use of resources. The system also maintains the same least privilege semantic of running individual services on separate machines, while making efficient use of machine resources at hand. For instance, an administrator could run MySQL and Exim mail transfer services on a single machine, but within different pods. If the Exim pod gets exploited, the pod model ensures that the MySQL pod and its data will remain isolated from the attacker.

The system can provide psychological acceptability by leveraging the knowledge and skills system administrators already use to setup system environments. Because pods provide a virtual machine model, administrators can use their existing knowledge and skills to run their services within pods. The system also increases the work factor required to compromise a system by not making available the resources that attackers depend on to harm a system once they have broken in. For example, services like mail delivery do not depend on having access to a shell. By not including a shell program within a mail delivery pod, one makes it difficult for an attacker to get a root shell that they would use to further their attacks. Similarly, the fact that one can migrate a system away from a host that is vulnerable to attack increases the work an attacker would have to do to make services unavailable.

Two examples are described below that help illustrate how some embodiments can be used to improve application availability for different application scenarios. The first application scenario relates to system services, such as e-mail delivery. Administrators like to run many services on a single machine. By doing this, they are able to benefit from improved machine utilization, but at the same time give each service access to many resources they do not need to perform their job. A classic example of this is e-mail delivery. E-mail delivery services, such as Exim, are often run on the same system as other Internet services to improve resource utilization and simplify system administration through server consolidation. However, services such as Exim have been easily exploited by the fact that they have access to system resources, such as a shell program, that they do not need to perform their job.

For e-mail delivery, some embodiments can be used to isolate e-mail delivery to provide a significantly higher level of security in light of the many attacks on mail transfer agent vulnerabilities that have occurred. Consider isolating an Exim service, the default Debian mail transfer agent, installation. Using pod virtualization, Exim can execute in a resource restricted pod, which isolates e-mail delivery from other services on the system. Since pods allow one to migrate a service between machines, the e-mail delivery pod is migratable. If a fault is discovered in the underlying host machine, the e-mail delivery service can be moved to another system while the original host is patched, preserving the availability of the e-mail service. With this e-mail delivery example, a simple system configuration can prevent the common buffer overflow exploit of getting the privileged server to execute a local shell. This can be done by just removing shells from within the Exim pod, thereby limiting the amateur attacker's ability to exploit flaws while requiring very little additional knowledge about how to configure the service. In addition, system status can be automatically monitored, and the Exim can be saved if a fault is detected to ensure that no data is lost or corrupted. Similarly, in the event that a machine has to be rebooted, the service can automatically be migrated to a new machine to avoid any service downtime.

A common maintenance problem system administrators face is that forced machine downtime, for example due to reboots, can cause a service to be unavailable for a period of time. A common way to avoid this problem is to use multiple machines to solve the problem. By providing the service through a cluster of machines, system administrators can upgrade the individual machines in a rolling manner. This enables system administrators to upgrade the systems providing the service while keeping the service available. The problem with this solution is that system administrators need to use more machines than they might need to provide the service effectively, thereby increasing management complexity as well as cost.

Pod virtualization in conjunction with hardware virtual machine monitors improves this situation immensely. Using a virtual machine monitor to provide two virtual machines on a single host, a pod can run within a virtual machine to enable a single node maintenance scenario that can decrease costs as well management complexity. During regular operation, all application services can run within the pod on one virtual machine. When one has to upgrade the operating system in the running virtual machine, one brings the second virtual machine online and migrates the pod to the new virtual machine. Once the initial virtual machine is upgraded and rebooted, the pod can be migrated back to it. This reduces costs as only a single physical machine is needed. This also reduces management complexity as only one virtual machine is in use for the majority of the time the service is in operation. Because applications need not be modified, any application service that can be installed can make use of this ability to provide general single node maintenance.

A second scenario relates to desktop computing. As personal computers have become more ubiquitous in large corporate, government, and academic organizations, the total cost of owning and maintaining them is becoming unmanageable. These computers are increasingly networked which only complicates the management problem. They need to be constantly patched and upgraded to protect them, and their data, from the myriad of viruses and other attacks commonplace in today's networks.

To solve this problem, many organizations have turned to thin-client solutions such as Microsoft's Windows Terminal Services and Sun's Sun Ray. Thin clients give administrators the ability to centralize many of their administrative duties as only a single computer or a cluster of computers needs to be maintained in a central location, while stateless client devices are used to access users' desktop computing environments. While thin-client solutions provide some benefits for lowering administrative costs, this comes at the loss of semantics users normally expect from a private desktop. For instance, users who use their own private desktop expect to be isolated from their coworkers. However, in a shared thin-client environment, users share the same machine. There may be many shared files and a user's computing behavior can impact the performance of other users on the system.

While a thin-client environment minimizes the machines one has to administrate, the centralized servers still need to be administrated, and since they are more highly utilized, management becomes more difficult. For instance, on a private system one only has to schedule system maintenance with a single user, as reboots will force the termination of all programs running on the system. However, in a thin-client environment, one has to schedule maintenance with all the users on the system to avoid having them lose any important data.

Using some embodiments, system administrators can solve these problems by allowing each user to run a desktop session within a pod. Instead of users directly sharing a single file system, each pod can be provided with three file systems: a shared read-only file system of all the regular system files users expect in their desktop environments, a private writable file system for a user's persistent data, and a private writable file system for a user's temporary data. By sharing common system files, some embodiments provide centralization benefits that simplify system administration. By providing private writable file systems for each pod, each user is provided with privacy benefits similar to a private machine.

Coupling pod virtualization and isolation mechanisms with a migration mechanism can provide scalable computing resources for the desktop and improve desktop availability. If a user needs access to more computing resources, for instance while doing complex mathematical computations, that user's session can be migrated to a more powerful machine. If maintenance needs to be done on a host machine, a system of various embodiments can migrate the desktop sessions to other machines without scheduling downtime and without forcefully terminating any programs users are running.

Various embodiments can be implemented as a loadable kernel module in Linux. In some embodiments, for example, a system may be implemented on a trio of IBM NetFinity 4500R machines, each with a 933 Mhz Intel Pentium-III CPU, 512 MB RAM, 9.1 GB SCSI HD and a 100 Mbps Ethernet connected to a 3Com Superstack II 3900 switch. One of the machines can be used as an NFS server from which directories can be mounted to construct the virtual file system for the other client systems. The clients can run different Linux distributions and kernels, for example, one machine can run Debian Stable with a Linux 2.4.5 kernel and the other can run Debian Unstable with a Linux 2.4.18 kernel.

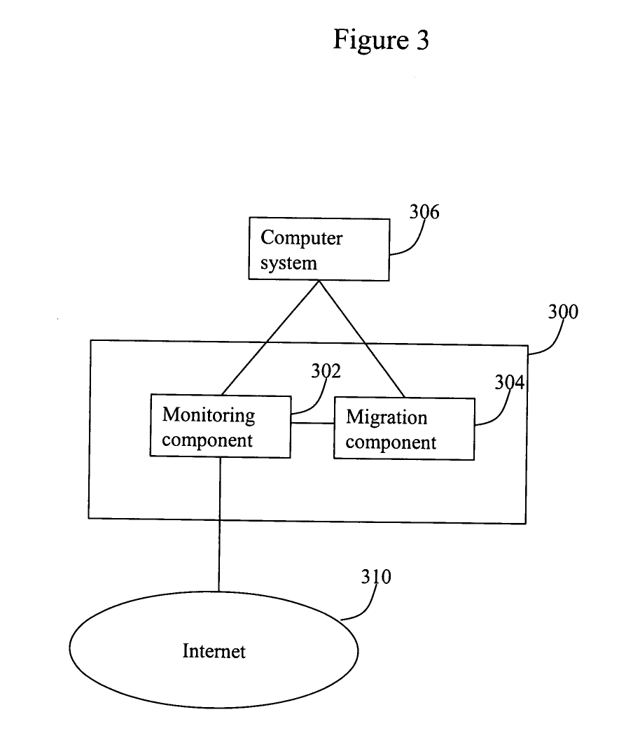

FIG. 3 is a block diagram illustrating a system 300 according to some embodiments. As shown, system 300 can include monitoring component 302 and migration component 304. Monitoring component 302 can be used to determine whether an operating system of computer system 306 needs to be updated. For example, monitoring component 302 can search for new security patches using Internet 310, or monitor faults in computer system 306. Upon determining that the operating system for computer system 306 needs to be updated, monitoring component 302 can instruct migration component 304 to perform a migration. Migration component 304 can, for example, suspend processes running in a virtualized operating system environment in system 306, save information relating to the processes, and transfer the saved information to a second virtualized operating system environment (not shown) to restart the processes therein. The second virtualized operating system environment can be in another computer system (not shown), or in computer system 306 (e.g., in a virtual machine in system 306). Although migration component 304 is shown to be separate from system 306, it may be combined with system 306 into a single unit. After migration, monitoring component can perform a desired operating system update in computer system 306.

Although some examples presented above relate to the Linux operating system, it will be apparent to a person skilled in the field that various embodiments can be implemented and/or used with any other operating systems, including, but not limited to, Unix and Windows operating systems. In addition, various embodiments are not limited to be used with computers, but can be used with any suitable digital processing devices. Digital processing devices can include, for example, computers, set-top boxes, mobile computing devices such as cell phones and PDAs, and other embedded systems.

Other embodiments, extensions, and modifications of the ideas presented above are comprehended and within the reach of one skilled in the field upon reviewing the present disclosure. Accordingly, the scope of the present invention in its various aspects is not to be limited by the examples and embodiments presented above. The individual aspects of the present invention, and the entirety of the invention are to be regarded so as to allow for modifications and future developments within the scope of the present disclosure. The present invention is limited only by the claims that follow.

What is claimed is:

1. A method for maintaining execution of a software process, comprising:
suspending one or more processes running in a first virtualized operating system environment on a first digital processing device;
saving information relating to the one or more processes;
restarting the one or more processes in a second virtualized operating system environment; and
updating an operating system of the first digital processing device.

2. The method of claim 1, further comprising determining whether a software patch for updating the operating system is available.

3. The method of claim 1, further comprising rebooting the first digital processing device.

4. The method of claim 1, further comprising monitoring the first digital processing device for faults in the first digital processing device.

5. The method of claim 1, further comprising:
determining a plurality of operating system resources that are needed by the one or more processes; and
restricting, for the one or more processes, use of the operating system to the plurality of operating system resources.

6. The method of claim 5, further comprising refusing access to the plurality of operating system resources by other processes running on the first digital processing device.

7. The method of claim 1, wherein saving information relating to the one or more processes comprises saving an intermediate representation of a state of the one or more processes.

8. The method of claim 1, wherein the second virtualized operating system environment operates in a second digital processing device.

9. The method of claim 1, wherein the second virtualized operating system environment operates in the first digital processing device.

10. The method of claim 9, wherein the first virtualized operating system environment operates within a first virtual machine in the first digital processing device, and the second virtualized operating system environment operates within a second virtual machine in the first digital processing device.

11. A computer-readable medium containing computer-executable instructions that, when executed by a processor, cause the processor to perform a method for maintaining execution of a software process, comprising:
suspending one or more processes running in a first virtualized operating system environment on a first digital processing device;
saving information relating to the one or more processes;
restarting the one or more processes in a second virtualized operating system environment; and
updating an operating system of the first digital processing device.

12. The computer-readable medium of claim 11, the method further comprising determining whether a software patch for updating the operating system is available.

13. The computer-readable medium of claim 11, the method further comprising rebooting the first digital processing device.

14. The computer-readable medium of claim 11, the method further comprising monitoring the first digital processing device for faults in the first digital processing device.

15. The computer-readable medium of claim 11, the method further comprising:
determining a plurality of operating system resources that are needed by the one or more processes; and
restricting, for the one or more processes, use of the operating system to the plurality of operating system resources.

16. The computer-readable medium of claim 15, the method further comprising refusing access to the plurality of operating system resources by other processes running on the first digital processing device.

17. The computer-readable medium of claim 11, wherein saving information relating to the one or more processes comprises saving an intermediate representation of a state of the one or more processes.

18. The computer-readable medium of claim 11, wherein the second virtualized operating system environment operates in a second digital processing device.

19. The computer-readable medium of claim 11, wherein the second virtualized operating system environment operates in the first digital processing device.

20. The computer-readable medium of claim 19, wherein the first virtualized operating system environment operates within a first virtual machine in the first digital processing device, and the second virtualized operating system environment operates within a second virtual machine in the first digital processing device.

21. A system for maintaining execution of a software process, comprising:
a migration component configured to migrate one or more processes in a first virtualized operating system environment on a first digital processing device by suspending the one or more processes, saving information relating to the one or more processes, and restarting the one or more processes in a second virtualized operating system environment, and
a monitoring component configured to determine whether an operating system of the first digital processing device needs to be updated, instruct the migration component to migrate the one or more processes upon determining that the operating system of the first digital processing device needs to be updated, and updating an operating system of the first digital processing device.
